(19) United States
(12) Patent Application Publication
(10) Pub. No.: US 2017/0081129 A1
(43) Pub. Date: Mar. 23, 2017

(54) SYSTEM AND METHOD FOR TRANSPORTING CONTAINERS IN AN INSPECTION ENVIRONMENT

(71) Applicant: Industrial Dynamics Company Ltd, Torrance, CA (US)

(72) Inventor: Jerry W. Parsons, Torrance, CA (US)

(21) Appl. No.: 15/263,987

(22) Filed: Sep. 13, 2016

Related U.S. Application Data
(60) Provisional application No. 62/218,407, filed on Sep. 14, 2015.

(51) Int. Cl. B65G 43/02; B65G 23/44; B65G 15/14

(52) U.S. Cl. CPC B65G 43/02; B65G 15/14; B65G 23/44; B65G 2203/0266; B65G 2201/0235

(57) ABSTRACT

A system and method for transporting containers within an inspection environment are described. Automated, adjustable pressures are applied to belts to ensure a constant amount of pressure is experienced by containers of various diameters during transport.

### RELATED APPLICATIONS

This application claims the benefit of U.S. Provisional Application No. 62/218,407, filed Sep. 14, 2015, which is fully incorporated herein by reference.

### FIELD OF TECHNOLOGY

This disclosure relates generally to inspection of containers, and more particularly to container inspection involving a container transport system capable of supplying a consistent pressure around the containers.

### BACKGROUND

Consumer beverages are subject to quality control standards, which often occur while on production lines. The production lines often involve automated transport of the beverage containers, such as bottles, through various stages of the production process. Transport of the containers may occur through the use of belts that contact sides of the containers. In order to beneficially and expeditiously transport the containers, a proper pressure needs be applied by the belts to the containers. If too much pressure is applied, the containers can jam, resulting in crashing of the containers. Conversely, if too little pressure is applied, the containers can slip out of the belts, also resulting in crashing of the containers.

Current systems are configured with a fixed separation to apply pressure to the belts. For example, the current systems are used to measure resistance on a can. When all of the containers to be transported have an identical diameter, this configuration results in an identical pressure being applied to all of the containers. However, this configuration experiences issues, such as those described above, when the transported containers have inconsistent diameters because the fixed separation of the belts results in various diameter containers experience varied forces. Issues also arise as the belts wear, resulting in an insufficient force being applied to the containers.

Accordingly, there is always a need for an improved container transportation system. It is to this need, among others, that this application is directed.

### SUMMARY

This application relates to a system and method for transporting containers within an inspection environment that can provide automated, relatively consistent pressures to transported containers regardless of the containers' diameters. The transport system and method include belts (or the use of belts) that transport containers over a “gap,” which is a location in the production line located between two conveyer sections to allow the insertion of inspection or coding components.

The system and method include two substantially identical conveyor sections. For example, each section or portion includes a belt maneuvered along a set of pulleys and a fixed member section that defines a pathway through which containers are transported. One of the conveyor sections can include a pressure transducer. One of conveyor section contains a movable member that allows for an automated adjustment in belt separation and therefore a consistent force to be exerted upon containers of various diameters being conveyed though the belt system.

### BRIEF DESCRIPTION OF THE DRAWINGS

The features, nature, and advantages of the present disclosure will become more apparent from the detailed description set forth below when taken in conjunction with the drawings in which like reference characters identify corresponding aspects throughout.

FIG. 1 illustrates a system for transporting containers within an inspection environment according to this disclosure.

FIG. 2 illustrates a method for transporting containers within an inspection environment according to this disclosure.

### DETAILED DESCRIPTION

This disclosure provides a system and method for transporting containers within an inspection environment. Two possible modes of operation exist for the disclosed system and method: (1) static setup and (2) automatic mode. In the static setup operation, the machine can be calibrated to use an optimal belt separation for a given bottle and the separation is allowed to be adjusted to achieve a constant force. In-production monitoring may be confined to raising an alarm when the force is too high/low.

However, the separation is not automatically adjusted upon the alarm being sounded. In the during production—automatic mode—operation, a sub-optimal condition is sensed as containers go through the system and separation is adjusted to attain an optimal separation for the “average” bottle currently being conveyed. In one example, the machine may have approximately five containers conveyed at a time. When this occurs, adjustment for individual container diameters may not be possible with the during production operation. Moreover, the present disclosure provided for short sections of belt separation to be adjusted to compensate for individual container diameters.

Separation of two belts is adjusted, relatively automatically, by a movable member to ensure a proper amount of pressure is exerted upon each container during transport. The system and method include two conveyor sections, each including a belt maneuvered along a set of pulleys and a fixed member section through which the containers are transported. One of the conveyor sections includes a pressure transducer (or differential pressure transducer) and movable member that allows for a consistent force to be applied by the belts on containers of various diameters. This allows for variations in the diameter of containers to be fluidly processed by the inspection environment without needing to manually tune the system during a production run. According to this disclosure; an adjustment of belt separation may be confined to small changes in response to varying container diameter, whereas gross changes in container diameter such as when different products are bottled, are adjusted by other input, such as product database to the belt separation adjustment system.

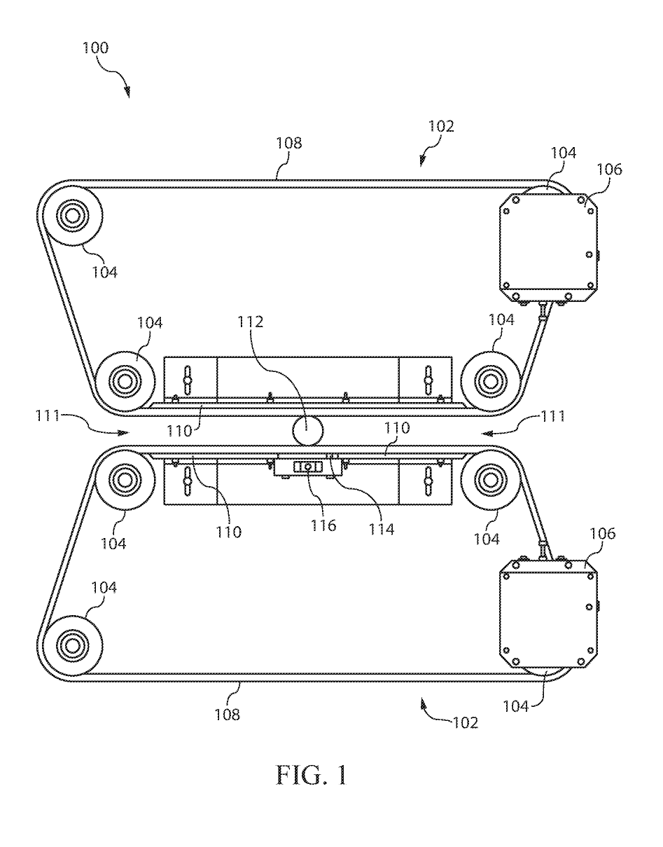

Referring to FIG. 1, a system 100 for transporting containers within an inspection environment is described. The containers capable of being transported by the system 100 include glass and plastic bottles, and aluminum cans, for example. Preferably, the system 100 transports glass bottles. The system 100 may move containers between various inspection components, such as an empty bottle inspection (“EBI”) components, pressure squeezer components, container bottom coding components, container orientation components, washing components, defect inspection components, filling components, capping components, and labeling components, for example.

The system 100 includes two conveyor sections 102. Each conveyor section 102 includes pulleys 104 and a control 106 (e.g., belt auto tensioning mechanism and motor coupled to drive pulleys) that drives belts 108 about the pulleys 104. The control mechanism 106 controls the speed in which the belts 108 move along the pulleys 104. For example, the control mechanism 106 may be a fixed speed apparatus that drives a corresponding belt 108 at a single, unvarying speed, or the control mechanism 106 may be a variable speed apparatus configured to drive the belt 108 at a desired, variable speed. The belts 108 may be moved at substantially identical or identical speeds. However, the belts 108 may be moved at different speeds to implement container rotation, provided the speeds of the belts 108 result in transportation of containers.

Each conveyor section 102 also has at least one fixed member 110 that operates with the at least one fixed member 110 of the corresponding section 102 to provide a pathway 111 through which the container 112 is transported. The fixed members 110 may be linear or non-linear, and parallel or non-parallel. For example, the fixed members 110 may be metal or some other substantially non-malleable, durable low-friction material such as oil loaded UHMWPE plastic. According to this disclosure, variable diameter containers may be transported by the belts 108 through the pathway 111. Therefore, the conveyor sections 102 and/or the fixed members 110 may be configured to have a distance between them that results in an adequate force, through the belts 108, being exerted upon a container having the largest diameter of the containers to be transported.

At least one of the conveyor sections 102 also includes a movable member 114 located between two fixed members 110. The movable member 114 may be centrally or substantially centrally located along the pathway 111. Alternatively, the movable member 114 may be centrally or substantially centrally located along the pathway and may be upstream or downstream. Additionally, the fixed members 110 that encounter the same belt 108 as the movable member 114 may be substantially equal in length. The movable member 114 may be metal or some other substantially non-malleable, durable low friction material. The movable member 114 is coupled to and operated on by a pressure/force/displacement transducer 116. When the container 112 has a maximum diameter of the containers to be transported, the movable member 114 may be substantially or exactly linearly aligned with the fixed members 110 that interact with the same belt 108 as the movable member 114. When the container 112 has a diameter less than the maximum diameter container, the pressure transducer 116 acts upon the movable member 114, causing the belts 108 to move closer together, resulting in an adequate force being applied to the container 112. As containers 112 are consecutively transported, the pressure transducer 116 (or other sensing means known in the art) may automatically calculate the force exerted by the container 112 in the pathway 111 and the location of the movable member 114. If it is calculated from the force exerted by the container 112 and the location of the movable member 114 that the force experienced by the container 112 is incorrect, the pressure transducer 116 may automatically move the movable member 114 to a location that results in an adequate force being applied to the container 112 as it is transported by the belts 108 through the pathway 111. Alternatively, the pressure transducer 116 (or other sensing means known in the art) may determine the diameter of the container 112 in the pathway 111 and a tension of the belt 108 in direct communication with the movable member 114 (e.g., using the tension to calculate the squeezing force being applied to the container). If determination of the diameter of the container 112 and the tension of the belt 108 concludes that the force experienced by the container 112 is incorrect, the pressure transducer 116 may automatically move the movable member 114 to a location that results in an adequate force being applied to the container 112 or subsequent similar containers as they are transported by the belts 108 through the pathway 111. Further, the transducer may be mechanically coupled to the mechanical linkage that spreads the belts (which experiences ore measures force from the container onto parts 110).

The pressure transducer 116 may be in communication with circuitry and other computer components that allow for detection of forces applied to containers and operation of the pressure transducer 116 as well as other computer methods where by the nominal positioning for a specific container is stored, to adjust the location of the movable member 114. An exemplary and non-limiting list of adequate forces exerted on containers includes forces sufficient to counter gravitation forces.

As described, the pressure transducer 116 is in the middle of the pathway 111. In this implementation, inspection may occur in the middle of the system 100. Alternatively, the pressure transducer 116 may be located at the beginning of the system 100, in which case inspection may occur at the beginning, middle or end of the pathway 111.

For example, belts 108 or other conveyor technology are used to move containers and apply a proper force to containers of varying diameters. However, belts are not needed for implementation of the system 100 described herein. For example, a foaming rubbery surface or surface made from numerous roller portions may be used to move containers and apply the proper force to the containers. In an illustrative example, the thick rubbery surface may be about ⅛ inch thick.

Alternatively, instead of the pressure transducer 116 described herein (i.e., a transducer that provides feedback to automatically change belt separation), the system 100 may include a pressure transducer that provides feedback to adjust the force on a constant force mechanism. The methodology may employ feedback based on “averages” (including weighted averages) or another suitable formula or parameter.

According to an embodiment, instead of the belts being configured to maintain a fixed gap, spring tensioned belt separation techniques may be implemented. This helps the system 100 grip different diameter containers. This also helps “self” adjustment of the gap for slightly ovular containers that need to be rotated during inspection. For example, use of a spring tensioned belt separation techniques may be beneficial in a linear empty bottle inspection (“EBI”) with outer sidewall inspection up and down stream of the system 100.

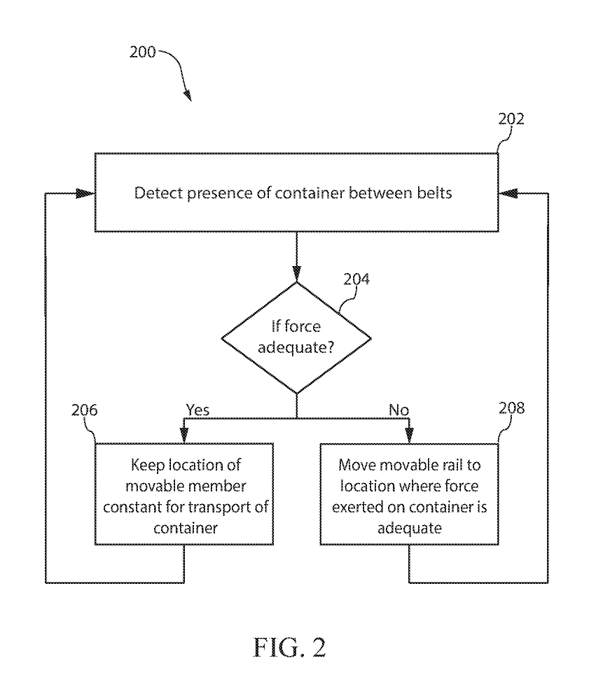

Referring to FIG. 2, this figure illustrates a method 200 for transporting containers within an inspection environment. At block 202, the presence of a container between transportation belts is detected. At decision point 204, it is determined whether a force exerted on the container is adequate. This may include determining a diameter of the container and a location of a movable member, and calculating, based on the diameter and location, the force applied to the container. This may alternatively include determining a tension of a belt in direct communication with the movable member, and using the tension to calculate the force being applied to the container.

The method and system can be incorporated inspections systems for containers, including bottles and cans.

If the force experienced by the container is adequate, the movable member is not moved while the container is transported by the belts (illustrated as block 206). If, however, the force is determined inadequate, the movable member is moved, to either increase or decrease the tension on a belt, to generate an adequate force exerted on the container (illustrated as block 208). When a subsequent container is determined between the belts (illustrated as block 202), the method 200 is performed with respect to the subsequent container.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular configurations of the process, machine, manufacture, composition of matter, means, methods, and steps described in the specification. As one of ordinary skill in the art will readily appreciate from the present disclosure, processes, machines, manufactures, compositions of matter, means, methods, or steps presently existing or later to be developed that perform substantially the same functions or achieve substantially the same result as the corresponding configurations described herein may be utilized according to the present disclosure. Accordingly, the appended claims are intended to include within their scope such processes, machines, manufacture, compositions of matter, means, methods, or steps.

What is claimed is:

1. A system for transporting a container in a container inspection environment, comprising:
belts that encounter sides of a container during transport of the container,
two conveyor sections each having a pulley and a control that drives one of the belts in a loop,
a movable member in communication with a belt, and
a pressure transducer in operable communication with the movable member, the pressure transducer moving the movable member when a force exerted upon the container is improper,
wherein movement of the movable member increases tension of one of the belts when the force exerted upon the container is too low.

2. The system of claim 1, wherein the control is a belt tensioning mechanism and a motor coupled to drive the belt.

3. The system of claim 1, further comprising:
fixed members in communication with the belts, the fixed members indirectly contacting the container through the belts.

4. The system of claim 1, wherein the movable member is located between two fixed members.

5. The system of claim 1, wherein the movable member is substantially linearly aligned with two fixed members when the container is a container of a plurality of containers having the largest diameter of the plurality of containers.

6. The system of claim 1, wherein the movable member is substantially centrally located along a transportation pathway of the system.

7. The system of claim 1, further comprising:
an alarm in communication with the pressure transducer, the alarm being triggered when In-production monitoring may be confined to raising an alarm when the force exerted upon the container is improper.

8. The system of claim 1, wherein a sub-optimal force is sensed as containers move through the system, and wherein separation of the belts is automatically adjusted to attain an optimal separation for an average diameter of the containers.

9. The system of claim 1, wherein the transducer is a pressure transducer.

10. A method for transporting containers in an inspection environment;
comprising the steps of:
detecting a container is between belts;
determining whether a force exerted on the container by the belts is adequate for transport of the container; and
moving a movable member to adjust the force exerted on the container when the force is inadequate to maintain a transportation rate of containers.

11. The method of claim 10, wherein movement of the movable member is automated by a pressure transducer.

12. The method of claim 10, wherein movement of the movable member is manually performed in response to an alarm being triggered.

13. The method of claim 10, wherein movement of the movable member is automatically performed when a sub-optimal force is sensed as containers move between the belts.

14. An inspection for bottles, comprising:
belts that continuously move bottles one after another along a path at a desired transportation rate,
two conveyor sections having a pulley and a control that drives one of the belts in a loop,
a movable member in communication with a belt, and
a pressure transducer in operable communication with the movable member, the pressure transducer moving the movable member when a force exerted upon the container is inadequate to maintain the desired transportation rate.
